(19) United States
(12) Patent Application Publication
(10) Pub. No.: US 2004/0244854 A1
(43) Pub. Date: Dec. 9, 2004

(54) Method of converting and amplifying a weak pneumatic signal into an enhanced hydraulic signal (JPHA method)

(75) Inventor: Vadym Buyalsky, Reisterstown, MD (US)

Correspondence Address: Robert H. Roche, CTRL Systems, inc., 1004 Littlestown Pike, Suite H, Westminster, MD, 21157-3026, US

(73) Assignee: CTRL Systems, Inc., Westminster, MD

(21) Appl. No.: 10/456,427

(22) Filed: Jun. 6, 2003

(51) Int. Cl. F15C 1/08

(52) U.S. Cl. 137/834

(57) ABSTRACT

Method of converting and amplifying a weak pneumatic signal into an enhanced hydraulic signal comprises a few of interrelated techniques: keeping free planar liquid high-speed jet-stream flow in steady-state compact quasi-parallelepipedic shape along its trajectory of free path throughout gas ambient of pneumatic control chamber; dividing pneumatic control chamber into two isolated cavities by said jet-stream flow and separating said pneumatic chamber from downstream adjacent intake hydraulic chamber by solid partition, slotted with jet stream passing channel; insulating low pressurized said control pneumatic chamber from highly pressurized said hydraulic intake chamber by forming locking liquid whirls in gaps between entire liquid side free surfaces of jet-stream flow and adjacent solid side surfaces of jet-stream passing channel; enhancing an impact of liquid jet-stream flow impulse upon output channels of intake hydraulic chamber by effecting thereupon with additional impulses of thrust reactive flows; creating inverse influence of positive or negative (distributed or lumped) gas pressure difference upon free surfaces of liquid jet-stream flow for its angle bending.

### REFERENCES CITED

UNITED STATES PATENTS

| | | | |
|---|---|---|---|
| 3,001,539 | September 1961 | Hurvitz | 137/83 |
| 3,024,805 | March 1962 | Horton | 137/597 |
| 3,030,979 | April 1962 | Reilly | 137/624.14 |
| 3,457,935 | July 1969 | Kantola | 137/81.5 |
| 3,590,840 | June 1971 | Hyer | 137/81.5 |
| 3,718,151 | February 1973 | Kazuma Matsui, et al. | 137/823 |
| 3,780,770 | December 1973 | Schwarz, et al. | 137/823 |
| 3,811,475 | May 1974 | Woods | 137/840 |
| 6,497,252 | March 2000 | Köhler, et al. | 137/828 |

Foreign patents

| | | | |
|---|---|---|---|
| 490950 | November 1975 | Buyalsky, | (Former USSR; U.S. Cl. |
| | | et al. | 137/83, Int. Cl. F 15c 1/14) |
| 521404 | July 1976 | Buyalsky, | (Former USSR; U.S. Cl. |
| | | et al. | 137/81.5, Int. Cl. F 15c 1/08) |

Other References

1. Elaboration and Investigation of the Jet Pneumo-Hydraulic Amplifier-Converter/V. Buyalsky—R&D Report, Moscow(USSR): Center of Technical and Scientific Information, Reg. Number # 6897108, 1980.

2. Some Experimental Results of the Jet Pneumo-Hydraulic Amplifier Examination/V. Buyalsky, et al.—Annual Proceedings of Kyiv Polytechnic University.—Kyiv:

“Vyshcha Shkola”, Ukraine, 1976.

3. A New Type of Fluidic Diverting Valve/Bahrton S—Proceedings of the Fourth Cranfield Fluidics Conference—Coventry, England, 1970, pp. A4-53 . . . A4-60.

4. Challenges for Total Integration of Microfluidic Chips/Bruce K. Gale—Internet Site: www.eng.utah.edu/˜gale/mems/—page updated on Sep. 5, 2002.

### FIELD OF THE INVENTION

This invention relates to integrated or modular Microfluidic systems. It relates in particular to micro or meso scaled final amplifiers of said Microfluidic systems. More specifically, the present invention discovers the art of fluid flows handling regarding a new procedure of converting and amplifying a weak pneumatic signal, optionally being retrieved from a microfluidic chip, into significantly enhanced hydraulic signal that is an enough powerful output of said chip to be a direct single stage input for any type of control valves for power hydraulic drives of various machines and mechanisms at industry and transport objects.

### BACKGROUND OF THE INVENTION

The basic functions of modem microfluidic devices are merging, mixing, separation or canalizing of gas and/or liquid flows in practicing of biological and chemical units for diagnosing or processing. However, creation of integrated and modular Microfluidic systems is impossible without microfluidic units that possess control functions. There are some attempts to realize anticipated control functions by use of micro fluidic amplifiers (e.g. refer to: Fluid jet controlled Microvalve/Wouter van der Wijngaart: Microfluidics-hydraulic systems on chip./Micro System Technology, S3, KTH/Info on Internet Site: www.s3.kth.se/mst/gru/2e1135forts/pdf/MST F11microfluidics010402.pdf ). However these low power amplifiers operate only as distributors of gas or liquid flows throughout micro scale channel's network and fail to reveal the great enough single stage amplifying gain. So, with the aim of interfacing low power outputs of microfluidic chips with much grater power control units of hydraulic drive, it's necessary to utilize such a process that enables one stage and direct converting and amplifying weak pneumatic signal into enhanced hydraulic signal. Moreover, regarding the micro scale of said converting, this anticipated process must possess high sensitivity, accuracy and reliability, that's why it must not be vulnerable to influence of mechanical moving parts and hazardous heat flux, magnetic, vibration, electric, radiation fields and aggressive chemicals. The well-known methods of one stage amplifying and converting pneumatic or hydraulic signals feature with very low power outputs, even when being realized not in micro but in meso scale. Having in mind advantages and disadvantages of known techniques of beam deflection type fluid amplifying, it seams to be reasonable to suggest for Microfluidic Integral or Modular Systems the novel method of jet-stream pneumatic-hydraulic amplifying-converting (JPHA method), see FIG. 1. The nearest ancestor to JPHA method is the method that has been developed by Robert L. Woods (see U.S. Pat. No. 3,811,475).

However, method of Robert L. Woods enabled the only low power pneumatic-to-hydraulic amplification because it:

didn't utilize high-speed (≧30 feet per second) cocurrent immiscible flows of liquid and gas at the pneumatic control zone and consequently didn't use one of the fundamental hydromechanical advantages of cocurrent flows, namely: “the more speed gradient—the more gain of transverse sensitivity of flow trajectory bending”;

hasn't provided for most preservation of impacting impulse of planar jet-stream liquid flow in hydraulic intake zone and therefore hasn't provided for sufficient enough the pressure gain factor (≧100) and pressure recovery gain (e.g. 0.7≦Kp≦1).

The suggested by the present invention is the JPHA method that has been made free of before-mentioned drawbacks. Moreover, JPHA method has been elaborated with the aim to utilize the hydromechanical advantages of at least two categories of pure fluid dynamic control: Cocurrent Flow Control and Stream Interaction Control (see FIG. 1), which feature of JPHA method shall enlarge its functional ability for Microfluidic Integral and Modular Systems as far as for various control units of Powerful Hydraulic Drive.

### SUMMARY OF THE INVENTION

This invention seeks to realize a sort of fluid jet-stream beam deflection by effect of pneumatic control flows (JPHA method) where high impulse liquid jet-stream flow neither does not mix nor chemically interact with entrained or transversely impacting flows of control gas. Since JPHA method involves both Cocurrent Flow Control (with lamination and demixing of cocurrent fluid flows) and Stream Interaction Control (with demixing of fluid phases), see FIG. 1, it seams to be eligible to define physically this novel method as “Method of control a steady-state interface/boundary layer between interacting and immiscible jet-stream flows or cocurrent flows of different densities”, or shortly—“Interface Control of Interacting Flows”, which the suggested JPHA method belongs to. This novel category of pure fluid dynamic control is shown as separate category at FIG. 1 with the aim to emphasize its hydromechanical origin as new development of existing categories thereof.

It is the principle object of the present invention to provide a technique of monitoring the restricted angle bending of high impulse compact planar liquid jet-stream flow by transverse low impulse static or dynamic pressure differential of cocurrently flowing and/or jet-stream acting control gas.

Another object of the invention is to provide a technique that enables to form planar compact high impulse liquid jet-stream flow and maintain the integrity of said flow as along all its free path throughout control gas ambient inside pneumatic control zone, as at an area of its entrance into an adjacent hydraulic intake zone.

It is further object of the invention to separate reliably said pneumatic control zone from openly connected thereto hydraulic intake zone with the aim to prevent the up-stream climbing of liquid flows from high pressurized hydraulic intake zone into pneumatic control zone that is being comparably low positively or even negatively pressurized therein.

A further object of the invention is to preserve the most of the initial impulse of said compact planar liquid jet-stream flow that goes inward hydraulic intake zone and impacts upon input areas of output facilities that are being arranged inside said hydraulic intake zone and designated to except said hydraulic impulse for making proper work.

Still another object of the invention is to enable the art that permits to utilize known high sensitivity of flexible elements of pneumonic two-ports and consequently to use said compact planar jet-stream liquid flow with entire side liquid-gas interfaces as moving flexible wall between adjacent-and-inverse pneumonic two-ports, which are being defined as isolated pneumatic cavities of said pneumatic control zone.

The specific nature of the invention, as well as other objects and advantages thereof, will clearly appear from the following description and the accompanying figures.

### BRIEF DESCRIPTION OF THE FIGURES

Preferred embodiments of the present invention will now be described with reference to the figures by way of illustration, in which hydromechanical fundamentals of the suggested novel JPHA method are represented, in which like reference characters indicate like elements of method arrangement, in which explanations of said arrangement are given, and in which:

FIG. 1 represents the actually new classification of control techniques of beam deflection type fluid amplification. This new classification has been composed on the bases of previous verbal classification, delivered by Billy M. Horton in his U.S. Pat. No. 3,024,805. The shown at FIG. 1 classification has been developed regarding the modem sophistication in pure fluid dynamic control. It properly illustrates as hydromechanical fundamentals of JPHA method, as its links with and its place amongst the available alternatives for control techniques of beam deflection type fluid amplifying.

FIG. 2 shows the schematic arrangement of interrelated techniques that comprise the suggested by the present invention the novel JPHA method. It illustrates graphically the interaction among all principal working hydromechanical and aerodynamical processes that altogether constitute the subject of the present invention as method of pure fluid pneumatic-to-hydraulic converting and amplifying, which method is actually the optional example of putting in practice the fundamental principles of before-mentioned novel category of pure fluid dynamic control, namely: Interface Control of Interacting Flows, see FIG. 1.

### DETAILED DESCRIPTION OF THE PREFERRED EMBODIMENTS

The preferable embodiments of the present invention are the novel techniques that comprise JPHA method itself. The following detailed description is expected to deliver the proper explanation of advantages of these techniques and their beneficial interaction at pneumatic-to-hydraulic converting and amplifying procedure.

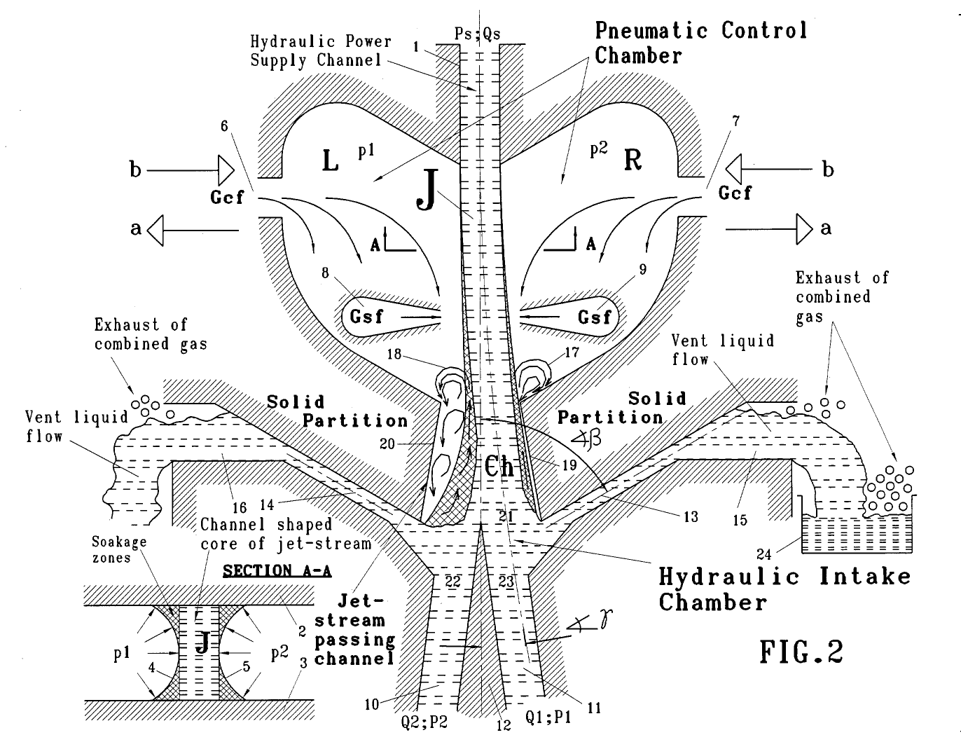

The high impulse quasilaminar free planar liquid jet-stream flow J is being organized to run from outlet portion 1 of hydraulic power supply channel and flow further between two preferably parallel solid plane surfaces 2 and 3, see FIG. 2. The conditions of keeping the core of jet-stream flow at nearly parallelepipedic shape along all its straight or bended trajectory of free path throughout the pneumatic control chamber are being enabled by:

matching the solid, liquid and gas stuffs so that they do not interact chemically;

calculating and forming the outlet portion 1 of hydraulic power supply channel so that to enable the quasilaminar distribution of flow speeds in any cross-section downstream of flow J core, which cross-section nearly repeats the rectangular shape of opening of outlet portion 1;

selecting a type of liquid, which is hygrophilous to a type of solid, so that it will enable to form the stabilizing soakage zones, see section A-A at FIG. 2, at all four lines of solid-liquid-gas interfaces along entire trajectory of said jet-stream liquid flow J on its free path throughout pneumatic control zone;

rating Re, We and St numbers of said flow J in such correlation that it will permit to avoid vulnerability of free side surfaces of flow J to undulation, turbulization and droplet breaking due to the steady effect of stabilizing surface tension upon liquid-gas interfaces, i.e. upon said free side surfaces;

choosing such optimal correlation among said Re, We, St numbers, length and area of said liquid-gas interfaces, and value of distributed or lumped effect of control gas pressure differential thereupon so that to avoid the extra bending and consequent breaking of channel shaped core of flow J.

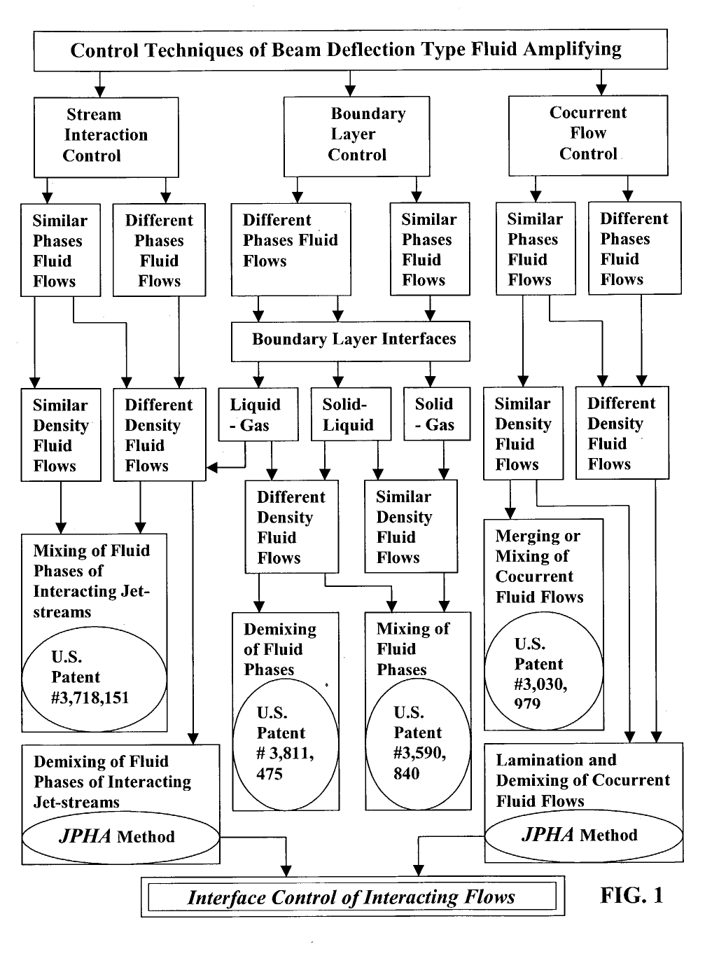

According to the JPHA method of the present invention, there is the necessity to arrange at least two adjacent but reliably separated chambers. One of them is the pneumatic control chamber, in which the angle bending of high impulse compact liquid jet-stream flow J is being accomplished by distributed or lumped effect of control gas pressure differential, e.g. Δₚ=p₁-p₂, see FIG. 2, where said jet-stream flow doesn't mix with surrounding control gas. The liquid jet-stream flow J is being arranged to divide the inside space of pneumatic control chamber into two isolated cavities L and R where each of two free side surfaces 4 and 5 of said jet-stream flow J faces the adjacent pneumatic cavity and functions as an elastic movable wall of said cavity. The high-speed liquid jet-stream flow J entrains cocurrent flows Gcf of control gas through input openings 6 and 7 of the cavities L and R, which ejecting phenomena is used for creating under-atmospheric pressure inside said cavities, hence converting each said pneumatic cavity into high-sensitive pneumonic two-port with elastic movable wall, where this wall is actually none other than said compact planar jet stream flow J. In accordance with the specific cocurrent flow control technique of the present invention (see FIG. 1), cocurrent gas flows do not mix with liquid flow J and do not interrupt free side surfaces 4 and 5 of flow J that are being under stabilizing effect of surface tension. So, control gas may be entrained through input openings 6 and 7 if they are connected to surrounding gas atmosphere (see arrows a). Otherwise, control gas may be undergone the force inflowing into cavities L and R through said input openings (see arrows b). Optionally control gas may be blown in cavities L and R in the form of gas stream flows (Gsf), coming alternatively from nozzles 8 or 9 and impacting transversely said free side surfaces 4 and 5, as if a high impulse gas jet-stream flow might impact a flexible moving wall (see FIG. 2). According to the specific stream interaction control technique of the present invention (see FIG. 1), the gas stream flows Gsf do not either mix with liquid flow J or interrupt free side surfaces 4 and 5 of this flow J.

The other of said chambers is the hydraulic intake chamber that is being separated from said pneumatic control chamber by a solid partition, which partition is being slotted with a jet stream passing channel Ch in the full depth of said pneumatic and hydraulic chambers. The hydraulic intake chamber is being established with an art that enables to carry out the following techniques:

intake of compact free planarjet stream J, flowing out from control pneumatic chamber and entering hydraulic intake chamber through the said jet stream passing channel Ch;

pressurizing said hydraulic intake chamber by high impulse flow J so, that summarized hydraulic pressure in manifold of said chamber is at least for two orders greater than total pneumatic pressure in cavities L and R;

sharing an impulse impact of said planar jet stream flow J into at least two submerged output hydraulic channels 10 and 11 that are being arranged aside at least one splitting facilities 12 in said hydraulic intake chamber;

forming the thrust reactive flows 13 and 14 from the excess of liquid that can't pass through said output hydraulic channels, and then routing said thrust reactive flows into enlarged vent liquid free flow channels 15 and 16;

deaeration of the vent liquid free flows inside said enlarged vent liquid free flow channels 15 and 16.

The procedure of transition of flow J from depressurized or low pressurized pneumatic control chamber into relatively high pressurized hydraulic intake chamber (see FIG. 2) comprises formation of locking fluid whirls 17 and 18 in gaps between each side free surface 4 or 5 of the planar jet stream flow and adjacent inward side solid surface 19 or 20 of the jet-stream passing channel Ch so that said locking fluid whirls 17 and 18 are being maintained at steady dynamic equilibrium in limits of hydraulically long jet-stream passing channel. The said locking fluid whirls are being created by a liquid-gas mixture, which climbs upstream from the hydraulic intake chamber and trends in vain to enter the pneumatic control chamber under the effect of pressure difference between said chambers but is being entrained back downstream by the jet-stream flow J entrapment. This phenomenon is being kept at any static or dynamic status of transversely flexible planar jet-stream flow J (i.e. axial, or statically bent, or vibrating status). The said formation of locking fluid whirls is being accomplished by the rated correlation of geometrical and hydraulic characteristics of the jet-stream flow J with geometrical shape and dimensions of the jet-stream passing channel, e.g. by the rated correlation of Re number for flow J in pneumatic control chamber and Re number for flow Ch in jet-stream passing channel.

Pressurization of entirely submerged hydraulic intake chamber is being realized by an impact effect of high impulse flow J onto the entrance opening 21 of said hydraulic intake chamber. The most of said impacting effect is being supplied upon input openings 22 and 23 of hydraulic outputs 10 and 11, said impacting impulse is being shared between at least two outputs 10 and 11 by at least one splitting facility 12. Unfortunately, the sufficient part of said hydraulic impacting impulse of flow J might be lost provided it would be used the traditional procedure where an excess amount of liquid, which can't pass through outputs 10 and 11, is being vented outward hydraulic intake chamber into some unpressurized reservoir. Nevertheless, in compliance with the present invention there has been suggested novel technique that comprises a rated arrangement of said extra amount of vent liquid into additional thrust reactive flows 13 and 14 (see FIG. 2). Usage of backpressure effect of said thrust reactive flows 13 and 14 upon the input openings 22 and 23 of adjacent hydraulic outputs 10 and 11 gives a profitable possibility not to loose the impulse of vent hydraulic flows but even to enhance pressurization of openings 22 and 23. The useful backpressure effect of said thrust reactive flows has been developed in the result of realizing the following new techniques:

increasing speed of liquid vent flows by means of aptly rated hydraulic resistance of channels 13 and 14, which are being set upstream before the rest enlarged part of free liquid vent flow channels 15 and 16;

spatially orienting said thrust reactive channels 13 and 14 upstream at an acute angles to the axis of flow J in initial neutral, i.e. not bended, position of its trajectory, see FIG. 2.

This is evident that flow J loses its initial impulse I_{I} whilst running along its trajectory of free path throughout control gas ambient inside the pneumatic control chamber. This phenomenon occurs due to the preferable influence of friction and adhesion at the liquid-solid interfaces. So, at the end of its trajectory of free path said flow J will possess a final impulse 12. Such impulse loss, which may be identified by impulse loss coefficient Ki=I₂/I₁, influence, in turn, losses of the output pressure P₁, P₂ and output liquid flow rate Q₁, Q₂. These losses are identified by pressure restore coefficient Kₚᵣ=(P₁+P₂)/Pₛ and flow rate restore coefficient (Q₁+Q₂)/Qₛ=K_{qr}, where Pₛ and Qₛ are hydraulic power supply pressure and flow rate respectively. According to the present invention said inevitable losses shall be compensated by the novel techniques of:

mentioned above arrangement of thrust reactive flows 13 and 14 at rated acute angle β to the neutral axis of flow J where that arrangement may be identified by coefficient of reactive flows upstream turn K_{β}=1+cos(β+γ), see angles β and γ at FIG. 2;

rated correlation of mass and surface forces, applied to flow J, which correlation may be identified by said impulse loss coefficient Kᵢ.

According to the art of the present invention, the rated hydraulic parameters of liquid flow from outlet portion 1 of hydraulic power supply channel, amount of flow J impulse loss and compensating arrangement of thrust reactive channels 13 and 14 are being interconnected by a calculating relation that may be identified as Formula of Pressure Recovery Coefficient. This calculating relation is being used for putting in correlation the specified (e.g. by Client) hydraulic parameters of outputs 10 and 11 (i.e. parameters of useful load) with hydraulic parameters of outlet portion 1 of hydraulic power supply channel (i.e. parameters of spent power). Said relation may be represented in formula:

Kₚᵣ=K*Kᵢ*K_{β} (1)

where K—is coefficient of proportionality, which has been defined on the basis of theoretically rated and experimentally retrieved data regarding the proper parametrical correlation between hydraulic power supply input 1 of pneumatic control chamber and useful load outputs 10 and 11 of hydraulic intake chamber. The efficiency factor of pneumatic-to-hydraulic conversion and amplifying method of the present invention may be represented in formula:

η=Kₚᵣ*K_{qr} (2)

These formulas (1) and (2) constitute the fundamentals for preliminary calculations at putting the suggested technique in practice.

According to the present invention, it was discovered that propulsive liquid flow J didn't either merge gas cocurrent flows or mix with them. This specific feature lets to define said new technique of pneumatic-to-hydraulic conversion and amplifying as a method of new category of Beam Deflection Type Fluid Amplifying, namely—Interface Control of Interacting Flows, see FIG. 1. Besides, there were revealed the following advantages:

compact planar liquid jet-stream flow J entrains control gas from cavities L and R and hence from the surrounding gas atmosphere through input openings 6 and 7 so that subatmospheric pressure is being aroused inside said cavities L and R, provided said input openings are fully opened into surrounding atmosphere (see arrows a);

impulse or monotonous change of speed of any gas cocurrent flow provokes high response change of pressure in corresponding pneumatic cavity in the same impulse or monotonous mode;

the main propulsive liquid flow J possesses high angle bending sensitivity to a change of pressure difference acting transversely upon its free side surfaces;

both side surfaces of liquid flow J keep integrity under influence either distributed pressure of cocurrent flows, acting semi-uniformly along all its trajectory, or lumped pressure, created by point forcing of gas stream flows 8 and 9 upon any of flow J side surfaces 4 and 5 like upon a moving flexible wall, see FIG. 2;

any throttling or blocking in full the input openings 6 or 7, otherwise the output openings 8 or 9 of gas stream channels Gsf, constitutes redistribution of gas pressure differential between opposite and inverse cavities aside said liquid flow J where it consequently results in angle bending of flow J trajectory.

Each of pneumatic control cavities (e.g. cavity L) has an input opening 6, output opening (in the form of gap between liquid surface 4 and solid surface 20) and flexible moving liquid wall in the form of flow J. Therefore, each said cavity L or R functions as pneumonic two-port with actively controlled input opening 6 or 7 and passively controlled output opening in the form of said gap. Gas stream flow channels 8 and 9 have been arranged to function independently of said pneumonic two-ports.

So, according to the present invention the main function of suggested technique of pneumatic-to-hydraulic converting and amplifying is angle bending of high impulse compact planar liquid jet-stream flow by transverse gas pressure differential, provided that liquid jet stream and control gas were in direct contact but didn't mix, merge or interact chemically. As it is being arranged at the present invention, said angle bending is being accomplished in analog or impulse modes by applying the following optional techniques:

increasing of vacuum rate in one cavity versus the other inverse cavity of the pneumatic control chamber, where said increasing is being fulfilled by throttling or blocking in full the draw input of gas (see arrows a at FIG. 2) inward the said pneumatic cavity from outside surrounding gas ambient;

decreasing of vacuum rate in one cavity versus the opposite inverse cavity of the pneumatic control chamber, where said decreasing is being carried out by the forced gas inflowing (see arrows b at FIG. 2) into the said pneumatic cavity;

impacting upon the side surfaces 4 or 5 of the jet-stream flow with a control gas jets Gsf, where said control gas jets are being applied upon said surfaces inversely;

applying distributed (by Gcf ) and lumped (by Gsf ) pressure differential either alternatively or simultaneously but ever at the same impulse or monotonous mode;

simultaneous increasing/decreasing of vacuum rate in the opposite inverse said cavities by said techniques, which are being applied in antiphase mode.

In accordance with the present invention the combined gas entrained by the flow J is being aerated from the working liquid during the evacuating movement of the vent liquid free flows 15 and 16. The art of aeration of combined gas from the working liquid is being realized in two consequent stages as follows:

the first stage of releasing the combined gas from draining liquid is being organized by converting the pressurized quasilaminar thrust reactive flows 13 and 14 into the slow-speed turbulent free running vent liquid flows 15 and 16;

the second stage of releasing the combined gas from turbulent slow-speed free running vent liquid flows is being accomplished by pouring down said flows upon free liquid surface of hydraulic reservoir 24 in the mode of developed turbulence.

Due to the successful development of modern Microfluidics and meso scaled Fluidics (especially for MEMS), and industrial Pneumatics and Hydraulics (in particular for automation and control), it is expected that JPHA method of the present invention shall be profitably used for creation of new class of pure fluid pneumatic-to-hydraulic converters and amplifiers, interfacing low power Microfluidic or Fluidic control units with control amplifiers of powerful hydraulic drives for adverse nomenclature of machines and mechanisms.

The present invention is not to be confined to the precise details herein shown and described, nevertheless changes and modifications may be made so far as such changes and modifications indicate no significant deviation from the sense and art of the claims attached hereto.

What is claimed as new and desired being secured by letter patent of the united states is:

1. Formation of two isolated chambers between two solid preferably parallel opposite plane plates, which chambers are being separated by a solid partition, containing a through channel that is being slotted in full depth of both said chambers and defined as jet-stream passing channel.
Defining the first chamber, as a pneumatic control chamber and organizing therein the steady-state flow of a free planar compact jet-stream so that said jet-stream flow will divide the inside space of said chamber into two independent pneumatic cavities, without mixing with surrounding control gas, and will flow into the second adjacent chamber through the said jet-stream passing channel of said solid partition. The jet-stream passing channel is being arranged so as to be hydraulically long and axial with an opposite outlet portion of hydraulic power supply channel, which is being established to open inward the said pneumatic control chamber.
Defining the second adjacent chamber, as a hydraulic intake chamber and processing therein the following techniques:
intake of compact free planar jet stream, flowing out from control pneumatic chamber and entering hydraulic intake chamber through the said jet-stream passing channel;
sharing an impulse impact of said planar jet-stream flow into at least two submerged output hydraulic channels that are being arranged aside at least one splitting facilities in said hydraulic intake chamber;
forming the thrust reactive flows from the excess of liquid that can't pass through said output hydraulic channels, and then routing said thrust reactive flows into the enlarged vent liquid free flow channels;
deaeration of the vent liquid free flows inside said enlarged vent liquid free flow channels.

2. Method as claimed in claim 1, comprising formation of the steady-state flow of a quasilaminar free planar jet stream, running along its free path trajectory throughout the pneumatic control chamber without mixing with surrounding control gas and dividing the inside space of said chamber into two separate and preferably symmetric pneumatic cavities, where each of two free side surfaces of said planar jet-stream flow faces the juxtaposed pneumatic cavity and functions as an elastic movable wall of said cavity. The state of steadiness of said planar jet-stream flow is being enabled in the result of creating rated conditions for proper use the surface tension effect at the gas-liquid-solid interfaces and constant maintaining of soakage zones at the liquid-solid interfaces of any side surface of said jet-stream flow.

3. Method as claimed in claim 2, which comprises proper selecting of relationship among physical and chemical characteristics of solid, liquid and gas stuffs for processing the claimed method, and comprises choosing of rated correlation among Re, We, St numbers of said quasilaminar free compact planarjet-stream flow so that the results of said apt selecting and choosing should enable performing the following techniques:
keeping the steady-state shape of each side free surface of jet-stream flow by using the stabilizing effect of surface tension forces upon solid-liquid and liquid-gas interfaces, including said stabilizing soakage zones, and therefore maintaining a nearly parallelepipedic shape of core of said free planarjet-stream flow;
avoiding the harmful undulation, turbulization and droplet breaking of both side free surfaces of the planar jet-stream flow, therefore keeping jet-stream flow core nearly invariable along all its straight or bended trajectory of free path throughout the said pneumatic control chamber and jet-stream passing channel, hence minimizing the loss of initial jet-stream flow impulse and so effectively pressurizing the entrance opening into hydraulic intake chamber;
arising the sub-atmospheric pressure inside both pneumatic cavities by creating proper conditions for entrapment of surrounding control gas by the running side free surfaces of the jet-stream flow, thus and so converting each said pneumatic control cavity into high-sensitive pneumonic two-port with elastic movable wall,
where this wall is actually none other than the straightly running or flexibly bending said free planar compact jet-stream flow.

4. Method as claimed in claims 3, comprising formation of locking fluid whirls in gaps between each side entire liquid free surface of the planar jet-stream flow and adjacent side solid surface of the jet-stream passing channel so that said locking fluid whirls are being maintained at steady dynamic equilibrium in limits of hydraulically long jet-stream passing channel. The said locking fluid whirls are being created by a liquid-gas mixture, which climbs upstream from the highly pressurized hydraulic intake chamber and trends in vain to enter the low positively or even negatively pressurized pneumatic control chamber but is being entrained back downstream by the jet-stream flow entrapment. This phenomenon is being kept at any static or dynamic status of planar jet-stream flow (i.e. axial, or bent, or vibrating status). The said formation of locking fluid whirls is being accomplished by the rated correlation of geometrical and hydraulic characteristics of the jet-stream flow with geometrical shape and dimensions of the jet-stream passing channel.

5. Method as claimed in claims 2 and 3, comprising an angle bending of compact planar jet-stream flow inside the pneumatic control chamber under pressure difference between the opposite inverse control pneumatic cavities of said chamber, which pressure difference is being organized by applying either distributed or lumped pressure, or both said kinds of pressure simultaneously, where said angle bending is being accomplished in analog or impulse modes by applying the following optional techniques:
increasing of vacuum rate in one cavity versus the other inverse cavity of the pneumatic control chamber, where said increasing is being fulfilled by throttling or blocking in full the draw input of gas inward the said pneumatic cavity from outside surrounding gas ambient;
decreasing of vacuum rate in one cavity versus the opposite inverse cavity of the pneumatic control chamber, where said decreasing is being carried out by the forced gas inflowing into the said pneumatic cavity;
impacting upon the side surfaces of the jet-stream flow with a control gas jets, where said control gas jets are being applied upon said surfaces inversely;
applying distributed and lumped pressure differential either alternatively or simultaneously but ever at the same impulse or monotonous mode;
simultaneous increasing/decreasing of vacuum rate in the opposite inverse said cavities by said techniques, which are being applied in antiphase mode.

6. Method as claimed in claim 1, comprising the art of forming thrust reactive flows from excess of liquid that can't pass through output channels of the hydraulic intake chamber, where said thrust reactive flows are being rated, designed and spatially positioned at an angle regarding the initial, not deflected trajectory of planar liquid jet-stream flow so that:
the thrust reactive impulse of each of said flows is being applied to the input zone of the adjacent hydraulic output channel;
the thrust reactive forces, acting on and hence enhancing pressure in said adjacent hydraulic outputs are being created by the rated throttling of excess liquid vent flows within said thrust reactive channels;
the high-speed thrust reactive flows are being converted downstream into the enlarged low-speed free running vent liquid flows, draining in turbulent flow regime outside of the hydraulic intake chamber.

7. Method as claimed in claim 1, comprising the art of deaeration of combined gas from the vent liquid free flows so that:
the first stage of releasing the combined gas from draining liquid is being organized by converting the pressurized quasilaminar thrust reactive flows into the turbulent slow-speed free running vent liquid flows;
the second stage of releasing the combined gas from turbulent slow-speed free running vent liquid flows is being accomplished by pouring down said flows upon free liquid surface of hydraulic reservoir in the mode of developed turbulence.
